(19) United States
(12) Patent Application Publication
(10) Pub. No.: US 2005/0182634 A1
(43) Pub. Date: Aug. 18, 2005

(54) Method of selling new sound recordings

(76) Inventors: Justin A. Zitler, New Orleans, LA (US); Jerry Brock, New Orleans, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002, US

(21) Appl. No.: 11/104,687

(22) Filed: Apr. 13, 2005

Related U.S. Application Data
(63) Continuation of application No. 10/218,129, filed on Aug. 14, 2002.

(51) Int. Cl. G11B 5/09; G11B 15/52; G11B 19/02

(52) U.S. Cl. 704/503; 704/500

(57) ABSTRACT

An original business method that significantly improves the recorded music industry-standard street release method (a coined term) of selling recorded music in the open-source CD format, by reconfiguring the use of conventional and Internet distribution channels; including first obtaining ownership and/or distribution rights in and to groups of approximately 100 new sound recordings featuring artists generally recognizable to the public within a definable genre of musical style, then creating a Golden digital songfile(a coined term) for each new sound recording acquired, utilizing any one of a number of suitable data compression/decompression technologies, then storing the GDS(s) in an open-portal database, then promoting and marketing the GDS(s) over the Internet through first-click access (a coined term) to genre-specific main music menus on any number of retail website(s), then offering the GDS(s) for electronic purchase to the computer consumer, then selecting certain Golden digital songfiles for crossover distribution (a coined term) through industry-standard street release method, then expanding the above formula to other groups of approximately 100 Golden digital songfiles featuring recognized artists in all definable music genres.

### CROSS-REFERENCE TO RELATED APPLICATIONS

This is a continuation of U.S. patent application entitled “An Original Way to Sell New Sound Recordings”, filed on Aug. 14, 2002, bearing Ser. No. 10/218,129, presently pending; and incorporates by reference herein U.S. provisional patent application Ser. No. 60/310,862, filed Aug. 9, 2001.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to an improved method for selling a new sound recording, and more particularly to an original method for selling a new sound recording that has been manipulated utilizing a suitable data compression/decompression technology to create a Golden digital songfile (“GDS”), where that GDS embodies a studio recording, a live music set, or any other new sound recording previously unreleased in open-source CD format. Even more particularly, the present invention utilizes the niche marketing strengths and global reach of Internet retail websites to digitally deliver the Golden digital songfiles directly to the public for sale before the new sound recordings are mass-produced in hard-copy open-source CD format for sale through the conventional street release method.

2. General Background of the Invention

The music recording industry has traditionally followed a street release business method whereby a music recording company (“label” or “record label”) expends money for the following sets of costs prior to the first dollar of revenue being generated through unit sales of the open-source CD on the date of street release:

First, production/acquisition costs are expended to produce or otherwise acquire ownership, reproduction and distribution rights in and to a new sound recording, together with costs involved in satisfying the compulsory statutory requirement for mechanical licensing of the underlying compositions embodied in the new sound recording(s).

Second, pressing and distribution costs are expended to mass-manufacture hard-copies of the new sound recording, including without limitation piano rolls, wax cylinders, vinyl long-playing records, vinyl 45 singles, cassette tapes, and CDs, package and distribute these hard-copy products of the new sound recording for sale to the public through normal retail channels such as retail record stores, mail-order catalogs or record clubs. The retailer returns unsold copies of the new sound recording to the label for discounted sale or waste disposal.

Third, and commonly occurring during and after the pressing and distribution process, promotional costs are expended to promote the hard-copy product sales of the new sound recording through various and sundry promotional efforts, including without limitation obtaining radio airplay through the services of independent radio promoters, print and broadcast media advertising, use of street marketing teams, touring support for live performances of the featured act on the new sound recording, co-operative marketing efforts with retailers such as direct payments for end-caps, shelf space and prominent physical placement of the new sound recording on record store retail shelves, promotional “CD release parties”, and other means of mass-marketing techniques designed to create consumer demand for the new sound recording. The traditional Street Release Method is illustrated in FIG. 4, while the Year 2000 Soundscan U.S. CD Album Sales Data and the Break-Even Chart are illustrated in FIGS. 1 and 2 respectively.

All of the aforementioned costs are expended by the record label on producing/acquiring, manufacturing, distributing, and promoting the new sound recording prior to any sales revenue inuring to the benefit of the record label (although additional promotional costs may be expended subsequent to the street release date). This business method is referred to herein as the street release method, because the date of release on the street through normal retail channels is the date whereby the first dollar of revenue accruing to the new sound recording (most commonly embodied in the open-source CD format) is generated. The street release method, having evolved and matured over the course of the 20^{th} Century, accounted for $40 Billion in worldwide sales of recorded music in the Year 2000, primarily in open-source CDs (see FIGS. 1 and 4).

However, the street release method is unable to accommodate itself to the Internet in the ordinary course of business. The Internet and data compression/decompression technologies enable personal computer users to share or to pirate an open-source CD, as that term is defined herein, without each user having to purchase the open-source CD from a retail outlet, or without physically possessing the open-source CD. Such file-sharing capabilities threaten the traditional music industry's bottom-line unit sales figures, upon which record labels depend in order to recover their significant advance cost investment for each new sound recording, because the industry leaders continue to manufacture open-source CDs for sale and distribution through the street release method, regardless of Internet opportunities.

Standard industry responses to the invention of the Internet and data compression/decompression technologies by those skilled in the music industry art are litigation against music destination websites, acquisition of controlling interest in the stock of such websites, and refusing the grant of blanket master recording usage licenses for digital distribution of the existing universe of open-source CDs owned by industry leaders, other than the grant of such blanket licenses to wholly or partially owned subsidiaries. Indeed, as of the date of filing the instant provisional application, the standard music industry practice for digital distribution of open-source CDs is to make available the record label's universe of existing catalog of open-source CD inventory to the computer consumer in consideration for a single monthly fee to subscribe to the record label's content providing subsidiary.

Because of the significant advance cost requirements for new sound recordings, the traditional street release music distribution marketing method demands maximum unit sales for the fewest number of album releases. Record labels expend far greater amounts promoting a few mass-marketed albums, thus causing an industry phenomenon whereby nearly all albums released each year do not realize commercial success, nor even public attention notwithstanding the artistic talent and merit of the new sound recordings (see FIG. 1).

In light of the new Internet and data compression/decompression technologies available, the street release method is disadvantageous to the record label because the vast majority of new sound recordings released to the general public do not realize sufficient sales for the record label to recover expended costs. In the street release business method, the sale of approximately 400,000 hard-copy units at top-line price is required for a record label to break even on any given new sound recording in CD format. Approximately one-third of one percent of all open-source CDs available for domestic sale in the year 2000 accounted for 56% of the total domestic sales revenue (see FIG. 1). Vast quantities of unsold open-source CDs and other hard-copy recordings and promotional materials become waste matter destined for disposal.

This marketing method is even more disadvantageous to the recording artist because the advance costs are credited to the artist's recoupment account, which must be zeroed out before the recording artist receives payment of his/her percentage of artist royalties on unit sales or licensing of the new sound recording. The street release method disenfranchises the vast majority of recording artists, for whom best-efforts promotion from their record labels is impossible in a street release method that requires mass-market saturation for the record label to break even on any given new sound recording. This situation is even more disadvantageous to the public domain, where the general public may never be aware of the musical works of talented but “unknown” or “unpromoted” recording artists and composers.

With respect to new sound recordings, the more recognized the artist, the less likely any departure from standard industry practice i.e.—from the conventional street release method will be. Those skilled in the music industry cannot depart from their street release method without deconstructing the entirety of a century old business model. Although compression/decompression and data encryption technologies are available for those skilled in the music industry to utilize this new method of selling Golden digital songfiles of new sound recordings, the industry leaders cannot do so without abandoning the contractual, licensing, marketing, promotion and distribution practices common to and accepted by the mature recorded music industry. This new business method is not only novel to those skilled in the prior art, it is so non-obvious as to be unthinkable within the business method they have so successfully developed in the pre-digital era. Indeed, as of the instant filing date, the stated industry standard objective for new sound recordings is to seek, utilize and deploy as-yet-unproven data encryption technologies designed to secure hard-product CDs from online piracy while nonetheless maintaining the street release method as the primary distribution channel.

The Internet and data compression/decompression technologies present a democratization of the music industry, providing worldwide distribution for any artist to create a new sound recording and sell it as a Golden digital songfile. However, all such prior attempts by artists, independent labels, and digital music distributors have failed to generate a viable business method, process or formula. Their failure (as distinguished from industry standard response to the Internet as a distribution channel, as detailed in the paragraph above) is due to self-branded music destination websites failing to utilize a genre-specific first-click marketing strategy as described in the present invention, inappropriately attempting to adopt the conventional mass-marketing strategies appropriate for conventional street release of recognized artists. The failure of self-branded music destination websites may be attributed further to lack of copyright compliancy, to giving away full-length electronic samples of songs by emerging talent, without recognizing that emerging talent may not sell a single CD, regardless of the distribution channel; and to futile attempts to aggregate distribution rights in and to a universal database of existing sound recordings.

### BRIEF SUMMARY OF THE INVENTION

The present invention recognizes the Internet as ideally suited for web-based niche marketing of new sound recordings, manipulated with data compression/decompression technology, whereby groups of related genre-specific Golden digital songfiles are sorted by recognized artists in definable genres, with first-click access to hyperlinks identifying said genres to the public on the main music menu web pages of as many retail website destinations as possible.

The present invention provides a novel, improved business method that exploits both the frictionless ease and cost-effectiveness of online music distribution and the established formula for generating a great deal of revenue by the street release of open-source CDs. Utilizing this business method, a digital-first record label would no longer risk the substantial advance costs associated with traditional hard-copy music distribution, would not risk online piracy, and would not be compelled to accept the return of significant numbers of unsold CDs. The digital-first record label need only utilize the street release method for those few sound recordings which have reached pre-determined download sales goals in the low cost/low risk digital environment, or alternatively, for those new sound recordings which have attracted rampant online piracy, thereby substantially reducing risk of loss due to advance costs, piracy, and unsold CDs, while increasing profit margins on all recorded music sales, whether digital or conventional.

Additionally, the recording artist benefits under the proposed business method because only the production/acquisition costs need be recovered by the record label from sales of the GDS before artist royalties begin to accrue (see FIG. 2). Further, production costs may be recouped from the revenue generated by the label's profit, not merely from the artist's nominal share of the label's profits on unit sales, as in the artist recoupment account for the street release method. Furthermore, the music publisher benefits under the proposed improved business method because they may be paid at statutory rate, or higher, for the songwriter's contribution to the new sound recordings.

It is an object of the present invention to provide a new and improved business method for selling new sound recordings.

It is a further object of the present invention to substantially improve a record label's ability to increase profit margins and substantially reduces financial risk on the sales of new sound recordings by, inter alia, creating a single Golden digital songfile for each new sound recording.

It is a further object of the present invention to substantially increase the profit share of the featured recording artist, and brings commercial viability to a far wider range of recording artists (see FIG. 1).

It is a further object of the present invention to significantly reduces the purchase price for consumers, and expands the product line of add-on features available to the consumer (i.e.—singles and video clips).

It is a further object of the present invention to provide increased revenue per composition for music publishers and provides additional revenue sources for music entertainment venues and performing artists.

It is a further object of the present invention to provide a far more ecologically sound than the traditional street release method.

In addition to these stated Objects, the goals of this new method is to provide an original and improved music business method that offers new sound recordings for sale to the public, which includes the steps of producing new sound recordings, or otherwise acquiring the right to reproduce and distribute such new sound recordings for sale to the public. The new sound recordings so produced or acquired must meet the criteria of commercial viability, as such term is used in the music industry, featuring unreleased new works by established recording artists in definable and recognized worldwide music genres (the New Orleans Music genre is the first preferred embodiment of the invention. Do not make, manufacture or reproduce any copies whatsoever of the new sound recordings. Each of the new sound recordings is kept and maintained solely and uniquely as a golden digital songfile (a coined term, see definitional section.) Proceed with designing album cover art and writing liner notes, just as if one were to release the new sound recordings through convention retail channels (sometimes referred to herein as Athe street release method's (ee definitional section); Do not proceed with manufacturing, reproduction, distribution and sale of copies of the new sound recording through normal retail channels (referred to herein as “crossover distribution” to the “street release method” (see definitional section) until after the following steps have been taken. Market the golden digital songfile to the worldwide public through first-click access (a coined term) to existing genre buttons in the main music menu pages of multiple retail destination portals, storefronts, or websites, including internet radio (in the first preferred embodiment, the main menu button would correspond to a genre of music, New Orleans Music) (in the second preferred embodiment, other genres of music, such as reggae, rock, country and western); The consumer purchases the golden digital songfile through credit card submission or some other form of electronic purchase; Pay a reasonable commission to all such retail websites on each sale of the Golden digital songfile. Only employ those websites that comply with the copyright requirements for performance royalties for both the underlying composition and for the sound recording. Pay full statutory mechanical license fee to the songwriter or his/her music publisher where applicable, for each sale of each song embodied in the golden digital songfile. Pay artist royalties after the initial costs of production or acquisition are recouped from gross profits, netting out only the website commission and the full statutory mechanical license fees; If any particular golden digital songfile sells more than its break-even point, depending on the costs of production or acquisition (see FIG. 3), then it is time to crossover to distribution through normal retail channels; Alternatively, if any particular golden digital songfile is rampantly pirated, then the popularity of the songs which occasioned such rampant piracy also mean that it is time to crossover to distribute the “hit” through normal retail channels.

Further, this new music business method of delaying conventional street release of new sound recordings in mass manufactured open-source CD format until after digital release substantially benefits the recording company, more particularly by eliminating the risk of pressing and distribution costs expended to mass-manufacture hard-copies of the new sound recordings, which costs are traditionally expended prior to the first dollar of revenue being generated; substantially reducing the promotional costs expended to promote the hard-copy product sales of new sound recordings, which costs are traditionally expended prior to the first dollar of revenue being generated; substantially reducing the risk of lost sales of new sound recordings, traditionally mass-manufactured for sales to the public in retail stores, but are now being pirated in cyberspace through file-sharing capabilities readily available to millions of would-be record buyers; substantially reduces the recording company=s significant advance cost investment structure as specified above in Claim #2.a, b, c, for each new sound recording, the recording company substantially increases its ratio of profitable to unprofitable album releases (see FIGS. 1 and 2).

Further, this new music business method of delaying conventional street release of new sound recordings in mass manufactured open-source CD format until after digital release substantially benefits the recording artists featured on each new sound recording, more particularly by further expands artistic expression of more and varied musical artists by moving away from conventional mass saturation marketing to niche genre marketing appropriate to the Internet; substantially increasing artist royalties, by offsetting the artist recoupment account against the net profits of the recording company, rather than by the artist's share of the net profits of the recording company, as is traditionally done now; providing a new and additional revenue stream accruing from digital sales from live performance venues.

Further, this new music business method of delaying conventional street release of new sound recordings in mass manufactured open-source CD format until after digital release substantially benefits the music publisher and songwriter affiliate whose compositions are embodied on each new sound recording, more particularly by receiving additional revenue of the full statutory rate for mechanical licenses for all recordings of their compositions sold in digital release, in addition to the performance royalties already being collected from websites that webcast music; increasing the demand for new songs and songwriters.

This new music business method of delaying conventional street release of new sound recordings in mass manufactured open-source CD format until after digital release substantially benefits the recorded music distributors and music retailers, more particularly by substantially reducing the extensive manufacturing, transportation, and storage costs involved with unsold CDs, that must be physically returned from the retailer and transported by the music distributor back to the recording company for disposal, by mass producing only those hard-product album CDs that have already been digitally pre-marketed as specified herein; adding an entirely new revenue stream to any music retailer that operates a website, by earning a commission on the sale of new sound recordings through their website.

This new music business method of delaying conventional street release of new sound recordings in mass manufactured open-source CD format until after digital release substantially benefits the music format radio stations, more particularly by adding an entirely new revenue stream to the Internet web cast affiliate of the terrestrial broadcast radio station, that revenue stream being the Aclick-on-buy@ feature defined herein in the first preferred embodiment of the invention, effectively generating a sales commission for each Internet radio listener who choose to buy the song that they are listening to on the Internet radio; adding the new revenue stream referred to and specified herein, the Internet radio station may now offset the cost of the sound recording performance royalty, together with the music publishing performance royalty.

This new music business method of delaying conventional street release of new sound recordings in mass manufactured open-source CD format until after digital release substantially benefits live music performance venues, more particularly by providing new and additional revenue from the digital sales of live performance sets.

This new music business method of delaying conventional street release of new sound recordings in mass manufactured open-source CD format until after digital release substantially benefits music destination websites and other retail websites, more particularly by providing a new and additional source of revenue from earned commissions on sales of new sound recordings, in addition to advertising revenue, and to revenue earned through subscription fees on existing catalog of old sound recordings; being fully copyright-compliant; monetizing the distribution of new content in an artist-friendly way.

Finally, this new music business method of delaying conventional street release of new sound recordings in mass manufactured open-source CD format until after digital release substantially benefits the public, more particularly by reducing substantially the retail cost for an album, as well as for single songs; making single songs more affordable than they are currently; permitting greater availability of other add-ons, such as single dongs, maxi-singles, enhanced singles, cover artwork, photos, extended liner notes, and music video clips; being ecologically more sensitive than conventional distribution by injecting into commerce only those music products that distributed by crossing over to the street release method (specified herein as claim #1.1.), thereby substantially reducing the waste product of unsold returns of all forms of hard-product (such as CDs, DVDs, cassettes).

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates the Year 2000 Soundscan U.S. CD Album Sales Data;

FIG. 2 illustrates the Break-Even Chart;

FIG. 3 illustrates the New Music Distribution Method; and

FIG. 4 illustrates the Traditional Street Release Method.

### DETAILED DESCRIPTION OF THE INVENTION

Prior to a discussion of the method of the present invention, for purposes of this application, the following terms set forth in Bold Print shall have the meanings as set forth below and their legal equivalents.

### Artist's Recoupment Account (Street Release Method)

The artist's recoupment account refers to the amount of money that must be recouped in order for the featured artist to commence receipt of artist's royalties. In the street release method, the artist recoupment account is offset only by the artist's share of royalties, sometimes referred to as the Basic Royalty Rate, not by the label's net profits as in the present invention. Typically, in the street release method, the Basic Royalty Rate is calculated as 10-18% of 130% of the lowest published wholesale price paid by the distributor on all albums sold and not returned, less a 25% deduction for packaging (sometimes referred to as a “container charge”), and less a 10-15% reduction for “free goods” or promotional CD giveaways. The Basic Royalty Rate is further adjusted downward in the typical street release method if unit sales occur in territories outside of the United States or Canada. These further adjustments, depending on the Value Added Tax applicable to each foreign territory, reduce the otherwise applicable Basic Royalty Rate by 50-85%. The current state of the art street release method contracts acknowledge that digital distribution exists, but categorize any revenue derived therefrom as a further reduction of 15-25% of otherwise applicable royalty rates, calculated in all respects similar to the other territorial deductions for Value Added Tax.

For example, assuming a recording artist with an industry generous 20% royalty rate, as calculated above, on a top-line CD that sells at retail for $17.99, such artist actually has an effective royalty rate of less than 10% of the retail list sales price, or approximately $1.80 per unit sold (and not returned) in the United States or Canada. In order for this recording artist to commence receipt of artist royalties, assuming the recoupment account has been credited with an industry low end $250,000 set of record label's recoupable expenditures, approximately 450,000 units would have to be sold to zero out the artist's recoupment account. For the sake of simplicity, the other revenue source available to the recording artist to offset the recoupment account, master-use licensing, is assumed to be zero in this example.

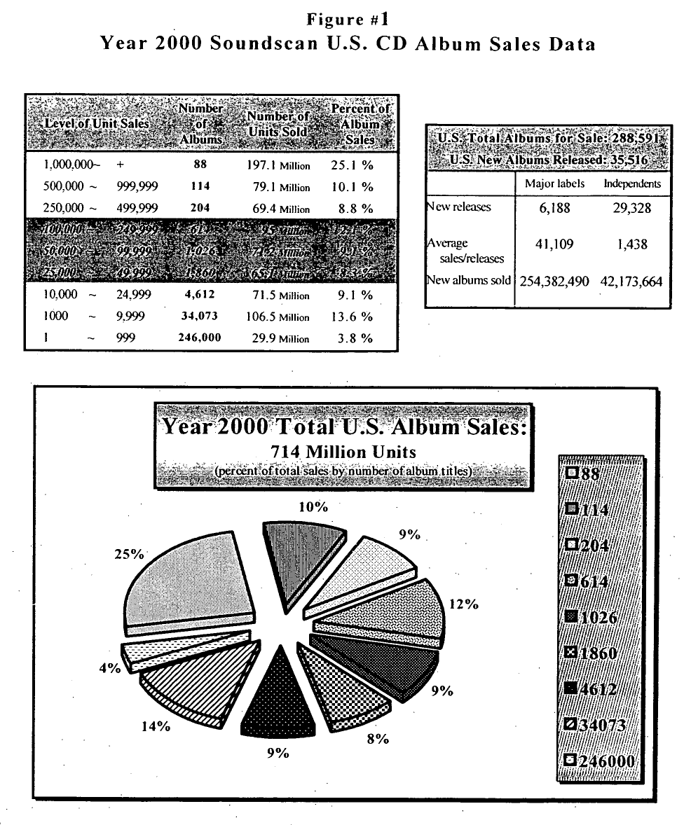

All recoupable expenses “fronted” by the record label must be recouped solely from the artist's share of royalties in order for the artist to receive artist royalties. Such unit sales figures are exceedingly rare in the street release method (see FIG. 1), and thus only a handful of recording artists ever receive royalties on hard-copy unit sales of their recorded work. It is standard industry practice to require the recording artist to agree to 5-7 renewal options, exercisable solely at the discretion of the record label, and cross collateralizing all revenues generated against the combined recoupment accounts of all new sound recordings. If the recording artist is also the songwriter, the record label will generally demand a controlled composition rate of: statutory on all owned or controlled compositions, capped at 10 compositions per album, and cross-collateralize these mechanical royalties as another expense credited to the artist recoupment account.

### Artist's Recoupment Account (The Preferred Embodiment of the Invention)

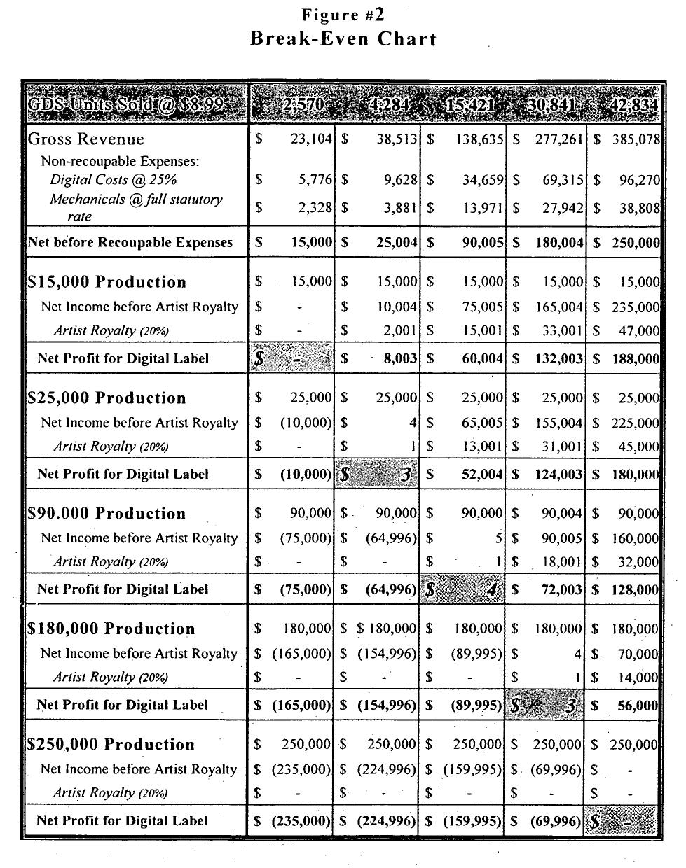

By way of contrast, the current invention assumes the same recording artist at the same 20% artist royalty, with the same amount of recoupable expenses at $250,000 (see FIG. 2). However, by NOT manufacturing CDs, and instead by first-click marketing of genre-specific recognized artists in a digitally exclusive environment, only 42,834 Golden digital songfiles would have to be sold at 2 of the street release method “top-line” price to consumers in order for the artist to commence receiving artist royalties. Thus, the break-even point in unit sales for the label (and for the artist) is the same in the current invention, and that point is approximately 10% of the break-even point for the artist in the street release method. By utilizing the current invention of digital first sales of the GDS through commission-based sales referred through many retail websites, and assuming the same album of recorded material, the record label's only item of recoupable expense is the production/acquisition cost, as that term is defined herein. Upon Internet sale of the GDS, as such term is defined herein, the record label then pays digital costs, as such term is defined herein, inclusive of full statutory mechanical royalties on all underlying compositions embodied in the GDS. With the new business method, the record label may then zero out the artist recoupment account with net profit after expensing the digital costs (see FIG. 2), at a break-even point of unit sales at 10% of those sales required by the street release method. The break-even point is further reduced to as low as 1% of those sales required by the street release method as the production/acquisition point drops below $250,000. The break-even point is further reduced yet again by sales of singles, maxi-singles, sheet music, video clips, cover art, and such related add-ons.

Having attained the desired level of unit sales in a digital-first environment, 42,000+ in this example, the record label may then avail itself of crossover distribution through the street release method, but now coming to the street release method with a proven seller in the digital first environment. For those GDS's that do not achieve a desired unit sales level, (or as is stated in the paragraph below, do not sustain online piracy interest), the record label utilizing the new method will simply reduce its risk of loss (see FIG. 1) by not pressing the product into CDs for crossover distribution, as that term is defined herein, and thereby considerably reduce the worldwide mass of non-biodegradable plastic.

Even online piracy of the GDS, in this example, notwithstanding the utilization of suitable data encryption technology, only hastens the crossover distribution through street release of what would be referred to in standard music industry terminology as a “hit”.

### Crossover Distribution

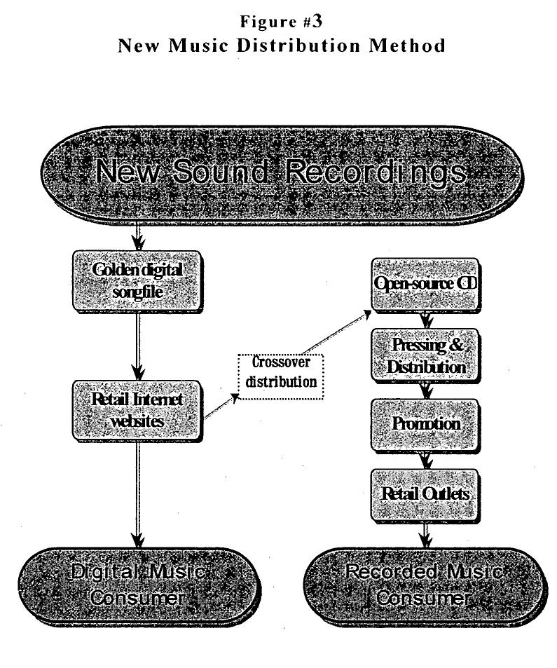

The term refers to the original method whereby the record label that owns the rights to the new sound recording and first distributes that new sound recording over the Internet through a recognized genre and first-click access on referring retail websites, may predict substantially more effectively than is permitted by the street release method the commercial viability of manufacturing and releasing that sound recording in traditional open-source CD format through normal retail sales channels (see FIG. 3). As used herein, crossover distribution is defined as the decision to repurpose the Golden digital songfile and to re-release the new sound recording (from which was created the Golden digital songfile by application of a data compression/decompression technology) into normal retail channels through the street release method in open-source CD format. Such decision is triggered either by achieving a break-even point in digital first sales, or by sustaining significant online piracy of the GDS.

### Data Compression/Decompression Technology

The term refers to compression/decompression software technology that facilitates the storage and transmission of large files onto computer disks or over the Internet. Commonly referred to by those skilled in the art as a “co/dec”, data compression/decompression technology essentially compresses the data in a digital file, making it more manageable and more easily transferred over the Internet. Having arrived at its destination computer, the compressed file is then “decompressed” to original size. Data compression/decompression technology is useful in that it takes up less space on a computer's memory, and it is more rapidly transmitted over the Internet. Numerous data compression/decompression technologies exist in the music and video arena, with and without data encryption technology, including without limitation a2b, EMMS, MP3 and LiquidAudio. Data Encryption Technology

The term refers to manipulating the Golden digital songfile by means of a suitable encryption technology such that permission, lockers, and key systems are utilized for the purpose of protecting the security and integrity of the digital file as it is transmitted over the Internet. At the very least, the data encryption technology functions to serve notice, audible and/or visibly to the consumer that it is a violation of copyright law under Title 17 of the United States Code to re-transmit, e-mail, or otherwise send the GDS to another without permission of the owner.

### Digital Costs

The term refers to any referring retail website=s commissions, as well as to any other licensing fees payable to the proprietor(s) of the data compression/decompression, data encryption and digital rights management technologies utilized.

### Digital Rights Management

This term generally refers to a package of software utensils that may accompany data compression/decompression technology, and that also may accompany data encryption technology. They may be used for permissions, but may also be upgraded to include instantaneous access to the monitoring functions required for pragmatic usefulness by a record label utilizing the new business method. For example, a digital record label utilizing this business method would want to utilize the functionality of royalty accounting for both the featured artists and the music publishers of all songs embodied in the GDS, and further utilize such royalty accounting by monitoring at any moment (in real-time) the number of sales pertaining to each add-on item contained or embodied in the GDS.

### Electronic Purchase

The term refers to using a credit card or other suitable electronic currency, to directly download the purchased songfile, or any combination of the group or groups of approximately 100 songfiles, onto the consumer's personal computers, or any add-ons contained or embodied in the GDS, permitting the purchaser to retain the GDS, or any part thereof, on the computer consumer's hard drive, export it to a portable device, write it or “burn it” onto a hard disc, or further transmit it electronically for sale to another computer consumer, utilizing one or more suitable data compression/decompression, data encryption, or digital rights management technologies.

### Electronic Sample

The term refers to a brief sound clip and/or audiovisual clip between 15 and 30 seconds in duration.

### First-Click Access

The term, as used herein, refers to the unique web-based niche marketing of genre-specific groups of Golden digital songfiles, such as New Orleans Music, Reggae, pop, rock, etc. Most retail websites that sell recorded music in any format, be it digitized or through mail-order sales of previously manufactured CD albums, have a main menu page with an information intensive listing of genres or styles of music available for purchase on that website. The consumer=s first-click from that main menu page is to the genre-specific style of music that the consumer is considering for purchase. The hyperlink from that style or genre of music (for instance, in this prototype New Orleans Music) links to the open-portal database where the GDSs are stored, wherever the server is located whereon resides the GDS, and howsoever the electronic purchase is consummated. First-click access, as used herein, is a marketing term that is specific to the Internet. More particularly, first-click access refers to the website that is hyperlinked to the genre specific main menu of recorded music products offered for sale on any number of retail destination websites.

### Golden Digital Songfile

The term, as used herein, is defined as a single digitized and mastered new sound recording, sometimes embodied in a digital audio tape, or DAT, encoded with a suitable data compression/decompression technology, such that a single GDS may be electronically transmitted over the Internet an infinite number of times, without perceptible loss of audio quality, at zero marginal duplication or reproduction costs. The data compression/decompression technology also functions to serve notice, audibly and/or visibly to the consumer, that it is a violation of copyright law under Title 17 of the United States Code to re-transmit, e-mail, or otherwise send the GDS to another without permission of the owner. The preferred embodiment of the present invention may include within the definition of Golden digital songfile, but is not limited to, data encryption technology and digital rights management software, as such terms are defined herein. The content of the GDS includes without limitation all tracks, or individual songs, comprising the new sound recording, together with all add-on items, such as single songs, multi-singles, video clips, sheet music, and cover art.

### Internet

The term refers to a system of computer networks interconnected by computers executing networking protocols that allow users to interact and share information over the networks, essentially without restriction.

### Internet Radio Station

The term refers to an Internet website that functions in a similar fashion to a terrestrial broadcast radio station. For purposes of the present invention, the defining feature and function of the Internet radio station is that the listener may purchase a particular song heard on the Internet radio station by directly downloading the song to the purchaser's hard-drive, whereas a listener may not so purchase a song from an ordinary radio station.

### New Orleans Music

The term refers to a widely recognized genre of music associated with New Orleans. It encompasses sub-genres such as Jazz, Blues, New Orleans R&B, Zydeco, Cajun, Funk, Mardi Gras music, and others.

### New Sound Recording

The term, as used herein, refers to a sound recording never before embodied or “pressed” into a digitized format for mass-reproduction. New sound recordings include without limitation freshly produced studio recordings, sound recordings released for sale to the public only in a non-digitized (analog) format such as vinyl long-playing records, 45 RPM vinyl singles, or cassette tapes, and venue sets of live performances.

### Open-Portal Database

The term refers to a computer database that is always accessible to Internet consumers, without that particular database having to be physically “opened” each time, and made Internet-accessible by logging on to the Internet, as is the case with a dial-up Internet connections.

### Open-Source CDs

The term refers to the compact disc, or to any other hard-copy format such as DVD, the data content of which has not been manipulated using a data compression/decompression standard, or any type of data encryption software technology. Open-source CDs are freely transmittable and duplicable utilizing the Internet. In the present invention, the term open-source CD is used primarily in reference to musical works, but may also include audiovisual works and motion pictures. For decades, record labels have commonly produced and distributed compact discs (“CDs”) bearing digitized sound recordings devoid of even the most rudimentary warning or protection against unauthorized compression/decompression distribution over the Internet. Personal computer users utilizing the appropriate computer hardware and software, such as a CD player/burner, sufficient hard drive space, a high speed Internet connection (i.e. a 56K, DSL or cable modem), and some type of compression/decompression technology, may store these open-source digitized sound recordings on their computer hard drives, then transmit them over the Internet to other personal computer users. Thus, theoretically, one bona-fide purchaser of an open-source sound recording can transmit that sound recording an infinite number of times to other music consumers over the Internet, thereby precluding the need for other listeners to purchase their own hard-copy sound recordings. Such online piracy, and the potential threat it poses to the recording industry's bottom-line unit sales figures, instigated the much-publicized Napster and MP3.com litigation that captured industry attention in 2000 and 2001.

### Pressing and Distribution Costs

Pressing refers to those sums expended to duplicate, or press the master copy into a hard-copy format such as a CD, and then to package the CD. Packaging costs include costs for the CD insert, or “liner”, for the plastic jewel case, and for any other packaging necessary for shipping the CDs. Distribution costs represent those substantial expenses associated with transporting, delivering and stocking the hard-copy sound recording. Further distribution costs include those sums required to return the unsold items of hard-copy product to the record label.

### Production/Acquisition Costs

The term refers to sums paid to the artist, to the other musicians or sidemen, to the producer of the sound recording, to other production personnel, to the studio where the sound recording in produced, to the writer of the liner notes that accompany the new sound recording and to the artist who creates the photos and/or other cover artwork that accompany the sound recording. The end result of the production process is a digital master copy of the sound recording, together with accompanying artwork and liner notes. Production costs may also be the acquisition costs paid by the record label to a production company that has already expended such production costs.

### Street Release Method

The term refers to the conventional distribution method utilized by the existing recorded music industry to offer their new sound recordings for sale to the public. Enormous amounts of advance money, time, and promotional effort are expended to generate pre-release publicity or “buzz” in order to enhance sales on the day of street release (which is always on a Tuesday) of any particular open-source CD album. The street release method is always executed and implemented one album at a time, not in groups related by genre or other natural musical grouping or sorting. A vast conventional infrastructure is finely tuned to place the (sometimes) millions of initial pressings, or hard-copy products, of the open-source CD at retail outlets throughout the country (and sometime throughout the world) on precisely the same Tuesday, and such distribution placement is coordinated with equally vast promotional and advertising efforts. If the open-source CD does not reach desired sales levels within a few months, its “shelf life” expires and is taken by the next new sound recording. The unsold open-source CDs are returned from the retail outlets, to the distributors, and ultimately to the labels, responsible for any further disposition or disposal thereof. After a new sound recording is produced or otherwise acquired by the record label utilizing this new business method, a suitable data compression/decompression technology is applied to the new sound recording, resulting in a Golden digital songfile. Groups of Golden digital songfiles are organized by genre or recognized style of music, and/or by recognized recording artist within such genres of music. As many retail websites as possible are then commissioned to add the name of the recognized genre of music (New Orleans Music in this preferred prototype embodiment of the invention, although other genres of music such as rock, Pop, reggae, etc. are already positioned on the website's main music menu web page) on the main menu webpage for music and entertainment products on such retail websites. The consumer's first-click access on the information-intensive main music menu webpage of any such affiliated retail website will then hyperlink to the server upon which resides the Golden digital songfile made available to the public for sale through electronic purchase.

Other terms used herein which may require some clarification are “commercial viability” (see FIGS. 2 and 3) which terms mean generally a recording artist with a track record of sales figure success above 24K units in traditional street release method, which number of sales cracks the nut, or breaks even, in the new method, but falls about 375K units short of breaking even in the street release method (a critical term defined herein). For the new sound recording to be commercially viable, the sales unit track record element must be present.

The next term is “niche marketing”. This element of the new method is appropriate to main menus of existing retail outlet websites that give consumers a choice of music available by genre (pop, metal, rock, country and western) . In the preferred test embodiment, New Orleans Music is a recognized, albeit very small in terms of worldwide sales, niche market, under which name would be a link to the NODE website for electronic purchase of the new sound recordings.

As used herein the term “copy” is important. One might ask how can you sell copies of the new sound recording when there are no copies, only a single GDS (golden digital sound file)? Title 17 defines copy in physical terms as an item of commerce manufactured by the copyright owner or its licensee. However, in the new method herein disclosed, one is not licensed the right to make copies in the old sense, until reaching the crossover distribution portion of the method; after digital distribution has either been rampantly pirated or has cracked its break-even number of digital sales. So, what then is sold to the digital consumer? The answer is he is sold the “right to make a copy” by downloading the GDS to his hard drive and burning it onto a blank CD. The customer has been allocated the “pressing and manufacturing” costs of making a “copy” because we have sold him the RIGHT to make that copy. That which is embodied on the blank CD, Which after burning really is a copy, is an ephemeral recording under the Digital Millennium Copyright Act.

Reference is made now to the details of the method of the present invention.

By niche marketing the new sound recording as a Golden digital songfile featuring recognized artists in definable genre-specific main music menus through existing Internet retail websites, utilizing one or more data compression/decompression technologies to create such Golden digital songfiles for each new sound recording, the record label is able to save the considerable sums traditionally advanced in the street release method for manufacturing, promoting, and mass-marketing hard-copy open-source CDs of each new sound recording, and to pass those savings along to the consumer, the music publisher, and to the recording artist. The Golden digital songfiles also provide additional profit centers for labels utilizing this new method, commonly referred to as add-ons, and known to those skilled in the music industry art as singles, maxi-singles, enhanced singles, sheet music, cover art, and music video clips.

The Golden digital songfile is purchased by Internet consumers for a price lower than the price they would have paid for a hard-copy open-source CD of the new sound recording. The record label utilizing this method is able to recover, or break even, on the costs advanced for the actual studio production/acquisition of the new sound recording after a specific number of online sales, as shown on FIG. 2. The break-even sales point is 1-10% of the number of hard-copy unit sales of open-source CDs that would be required to break even utilizing the traditional street release method.

In addition to enabling the record label utilizing this method to pass along a lower cost for the Golden digital songfile to the music consumer, the record label may also begin paying artists' royalties immediately upon recovery of the production/acquisition costs, effectively eliminating the artist recoupment account so entrenched in the street release method.

Then, the record label utilizing this business method may repurpose these online sales figures to predict which new sound recordings warrant the risk of crossover distribution, as that term is defined herein, to hard-copy open-source CD format through conventional street release method. Golden digital songfiles that realize a substantial number of online sales, or those new sound recording subjected to substantial online piracy are far more likely to achieve significant crossover distribution open-source CD sales than those new sound recordings initially released as open-source CDs utilizing the old street release method. Initially exclusive online marketing of a Golden digital songfile therefore functions not only as to its original purpose of making a profit in the digital environment, but also the GDS may serve the further purpose of digitally testing the music-buying market before the label utilizing this method incurs significantly more substantial costs to press, distribute, and promote hard-copies of the new sound recording as an open-source CD in the street release method.

A record label will first acquire ownership or distribution rights to genre-related groups of unreleased, newly recorded or out-of-print sound recordings, whether single songs, albums or any combination thereof, featuring recording artists of recognized stature in a definable genre or style of music. In both the old method and this improved method, the record label will still have to pay money in order to acquire groups of new sound recordings. However, these production/acquisition costs are minor compared to the additional costs of traditional manufacturing, promotion, distribution, and retail mark-up associated with hard-copy retailing of an open-source CD in the street release method.

Subsequent to production and/or acquisition, each new sound recording will then be manipulated using a suitable data compression/decompression technology, as the term is defined herein, into a Golden digital songfile, as that term is defined herein. One essential element is that each new sound recording will not have been previously released in open-source CD format, so that the Golden digital songfile may be protected by suitable data compression/decompression technology, at least to some degree, from online piracy. This protection is legally enforceable through Title 17 of the U.S.C., including without limitations amendments such as the DMCA (Digital Millennium Copyright Act). Additionally, the Golden digital songfile may include an array of add-on features, for example, single songs, video clips of choreographed derivative works of the songs, sheet music, photos and other artwork.

Next, these groups of Golden digital songfiles will be stored in an Internet accessible, open-portal database linked to existing Internet retail sites. On these Internet retail sites the groups of Golden digital songfiles will be offered for sale to consumers visiting the website. In this prototype of the new business method, the Golden digital songfiles will be offered for sale under a genre-specific heading, such as New Orleans Music. This business method extends as a matter of course to other recognized genres of music, such as rock, world, pop, folk, reggae, classical, etc. By clicking on the hyperlink for a particular genre of music, such as New Orleans Music, consumers will be directed to a webpage where they are able to listen to a short electronic sample of a particular Golden digital songfile, and are further able to click on a BUY command, thereby downloading the Golden digital songfile, or any portion thereof, onto their hard drive for a price. Consumers desiring to purchase a particular Golden digital songfile will be able to do so using a credit card or some other form of electronic currency. Having submitted their purchasing information to the Internet retailer, the consumer will then be able to download the GDS onto his own personal computer. The Internet retailer will receive a commission on each GDS purchased through its website.

In addition to selling these Golden digital songfiles through the music pages of Internet retail websites, a record label may also make the GDSs available for listening and purchase through an Internet radio station. In addition to the electronic purchaser downloading the Golden digital songfile to the hard-drive of a personal computer, the consumer may also be able to export the GDS to a portable device, to write or “burn” the GDS onto a blank compact disc utilizing the CD-R drive of the personal computer, or to further distribute the GDS for electronic purchase by other computer consumers.

Golden digital songfiles initially released and sold over the Internet will reach a break-even point when enough online sales revenues have been realized to equal the amount expended for acquiring or producing the new sound recording. The online sales revenue required to break even is net of the digital costs involved in this original method (see FIG. 2).

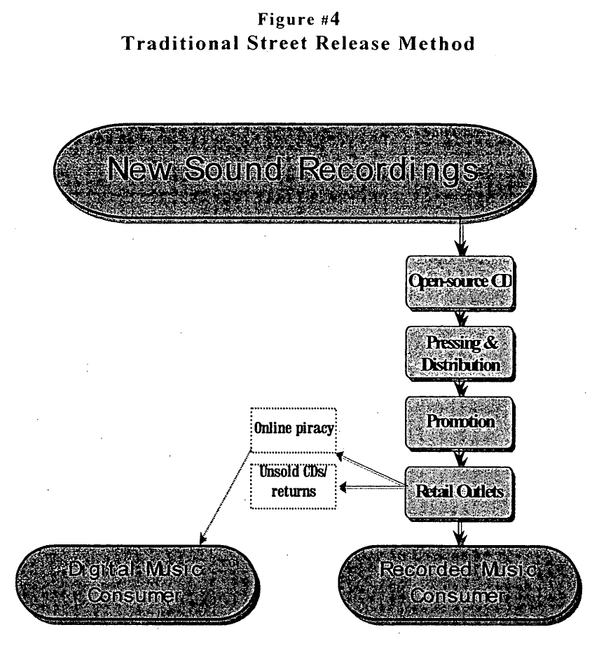

Having reached a break-even point, the record label may then engage in crossover distribution by mass-manufacturing and distributing hard-copies of a particular new sound recording that has achieved break-even or profitable online status as a GDS. Alternatively, the record label may select new sound recordings for crossover distribution where there exists a significant number of downloads of a Golden digital songfile occasioned by online piracy. The record label may also grant a license for crossover distribution of any new sound recording whose commercial viability has been proven as a GDS in one or both of these ways to third parties, including the traditional distributors affiliated with the industry leaders in the recorded music street release method (see FIG. 4).

A further embodiment of the present invention includes in the data compression/decompression technology utilized, a data encryption mechanism functioning to further safeguard the Golden digital songfile from online piracy. A further embodiment of the present invention includes in the data compression/decompression technology utilized, a digital rights management software program for tracking sales of each GDS, together with all singles and add-ons related thereto, for charting demographic information associated with each GDSs sales performance, for calculating and instantaneously monitoring the royalty accounting owed to various rights holders due to Internet sales of the GDS.

The present invention is significantly advantageous over the traditional street release method in that it substantially reduces the sum of money put at risk prior to revenue-generating sales activity, substantially decreases the amount of money required for the record label to break even on any given new sound recording, and substantially reduces the risk that monies that are advanced by the record label to promote, press and distribute a new sound recording in open-source CD format will not be recovered due to insufficient sales.

The present invention utilizes the Internet to provide a convenient and cost-effective business model for sales of new sound recordings, as GDS's, and further utilizes the Internet in this useful and novel method for testing the commercial appeal of a particular GDS prior to its manufacture and release in hard-copy open-source CD format. The present invention permits a far greater number of recording artists, specifically that vast majority of artists who are not among an elite few artists fortunate enough to receive avid promotion by the dominant record labels, to share in the democratization of music permitted by frictionless, efficient and cost-effective Internet delivery technologies.

Furthermore, the present invention provides an additional and significant environmental advantage over the traditional street release music distribution method because the number of unmarketable hard-copies of an open-source CD will be greatly reduced as a result of the digital test marketing aspect of the new sound recording embodied as a Golden digital songfile. There will be fewer quantities of open-source CDs returned to the record label and destined for waste disposal or destruction. Less energy and material resources will be expended on manufacturing, transporting and storing unmarketable open-source CDs.

While the present invention has been particularly shown as described with reference to a preferred embodiment, it will be understood by those skilled in the music industry art that various changes in form and detail may be made herein without departing from the spirit and scope of the invention. It is contemplated that various modifications can be made without departing from the spirit and scope of the present invention. The foregoing embodiments are presented by way of example only; the scope of the present invention is to be limited only by the following claims.

1. An improved music business method that offers new sound recordings for sale, comprising the steps of:
a) selecting recognized artists and song writers in a definable genre of music;
b) acquiring sufficient intellectual property rights from said artists and song writers to produce, copy and distribute new sound recordings for sale;
c) producing new sound recordings:
d) maintaining each of the new sound recordings as a golden digital song file as defined herein;
e) designing album cover art and writing liner notes in a conventional manner known as the street release method, as defined herein;
f) marketing the golden digital song files within said definable genres to a worldwide public through first-click access through genre hyperlinks on the main music menu pages of multiple retail destination portals, storefronts, and websites, including internet radio; and
g) then, only after certain criteria, releasing the golden digital song files to traditional record manufacturing companies for crossover distribution through normal retail channels.

2. The method in claim 1, further comprising the step of paying a reasonable commission to all such retail websites that comply with the copyright requirements for performance royalties for both the underlying composition and for the sound recording on each sale of the Golden digital song file;

3. The method in claim 1, further comprising the step of paying full statutory mechanical license fee to the songwriter, or his/her music publisher where applicable, for each sale of each song embodied in the golden digital songfile; and

4. The method in claim 1, further comprising the step of paying artist royalties after the initial costs of production or acquisition are recouped from gross profits, netting out only the website commission and the full statutory mechanical license fees.

5. The method in claim 1, whereby if any particular golden digital songfile sells more than its break-even point, depending on the costs of production or acquisition, then resorting to crossover to distribution through normal retail channels, all referred to as the street release method as defined herein.

6. The method in claim 1, whereby if any particular golden digital songfile is rampantly pirated, then the popularity of the songs which occasioned such rampant piracy also mean that it is time to crossover to distribute the hit through normal retail channels, also known as the street release method as defined herein.

7. The method in claim 1, wherein the certain criteria to be met in order to proceed to step g), is comprised of internet sales of the golden digital song file embodying a new sound recording meeting the break even point for digital sales (as shown on the Break-Even Chart, FIG. 2), or is comprised of the GDS embodying the new sound recording being subject to significant online piracy.
